(19) United States
(12) Patent Application Publication
(10) Pub. No.: US 2025/0121728 A1
(43) Pub. Date: Apr. 17, 2025

(54) BIDIRECTIONAL CONCURRENT CHARGING SYSTEM

(71) Applicant: Gustavo Adolfo Fortmann, Novi, MI (US)

(72) Inventor: Gustavo Adolfo Fortmann, Novi, MI (US)

(21) Appl. No.: 18/916,513

(22) Filed: Oct. 15, 2024

Related U.S. Application Data
(60) Provisional application No. 63/590,800, filed on Oct. 17, 2023.
(60) Provisional application No. 63/663,228, filed on Jun. 24, 2024.

(51) Int. Cl. B60L 53/65; B60L 53/62; B60L 53/66

(52) U.S. Cl. CPC B60L 53/65; B60L 53/62; B60L 53/66; B60L 2210/12

(57) ABSTRACT

An electric vehicle charging system includes a charging system controller having a processor and computer-readable memory, and a DC power converter. A DC Bus has at least a positive and a negative set of voltage lines. At least two charging dispensers are in electrical communication with the DC power converter along the DC Bus. Each of the at least two charging dispensers is electrically connectable to an electric vehicle. The charging system controller is configured to: acquire a target inlet voltage requested by a first chargeable electric vehicle; acquire a target inlet voltage requested by at least one subsequent chargeable electric vehicle; control a voltage of the DC Bus to correspond to the target inlet voltage requested by at least one chargeable electric vehicle; and connect a chargeable electric vehicle having a target inlet voltage corresponding to the voltage of the DC Bus, thereby enabling charging or discharging.

### CROSS REFERENCE TO RELATED APPLICATION

This application claims benefit of U.S. Provisional Application Ser. No. 63/590,800 filed Oct. 17, 2023 and entitled “Concurrent DC Charging System” and U.S. Provisional Application Ser. No. 63/663,228 filed Jun. 24, 2024 and entitled “Bidirectional Concurrent DC Charging System,” the entire disclosures of which are incorporated herein by reference.

### FIELD OF THE DISCLOSURE

The present disclosure is generally related to electric vehicle charging and more particularly is related to systems and methods for charging multiple electric vehicles.

### BACKGROUND OF THE DISCLOSURE

Likely the largest barrier to achieving widespread adoption of electrical vehicles (EV) is the unavailability of an acceptable recharging infrastructure. Commercial charging stations for recharging multiple electric vehicles suffer from a number of problems. As a first matter, the charging capacity on any individual charging dispenser is severely limited to a fraction of the maximum source power provided to the charging station. In order to construct charging stations with high-capacity individual charging dispensers, very large power converters must be provided for each dispenser to regulate the voltage of the power being provided to a connected vehicle and provide the highest current possible. The result is that these systems are complex, prohibitively expensive, and difficult to build.

Thus, a heretofore unaddressed need exists in the industry to address the aforementioned deficiencies and inadequacies.

### SUMMARY OF THE DISCLOSURE

Embodiments of the present disclosure provide a system and method for charging an electric vehicle. Briefly described, in architecture, one embodiment of the system, among others, can be implemented as follows. An electric vehicle charging system includes a charging system controller having a processor and computer-readable memory. A DC power converter is included. A DC Bus has at least a positive and a negative set of voltage lines. At least two charging dispensers are in electrical communication with the DC power converter along the DC Bus. Each of the at least two charging dispensers is electrically connectable to an electric vehicle. The charging system controller is configured to: acquire a target inlet voltage requested by a first chargeable electric vehicle; acquire a target inlet voltage requested by at least one subsequent chargeable electric vehicle; control a voltage of the DC Bus to correspond to the target inlet voltage requested by the first chargeable electric vehicle; and connect any of the first chargeable electric vehicle or the at least one subsequent chargeable electric vehicle having a target inlet voltage corresponding to the voltage of the DC Bus, thereby enabling charging of any connected electric vehicle.

The present disclosure can also be viewed as providing methods of charging a plurality of electric vehicles. In this regard, one embodiment of such a method, among others, can be broadly summarized by the following steps: providing a charging system having: a charging system controller having a processor and computer-readable memory, a shared DC power converter, a DC Bus comprising at least a positive and a negative set of voltage lines, and at least two charging dispensers in electrical communication with the shared DC power converter along the DC Bus, each of the at least two charging dispensers electrically connectable to an electric vehicle; attaching a first electric vehicle and at least one subsequent electric vehicle to the charging system at any of the at least two charging dispensers; commencing a charging process of the first electric vehicle; acquiring a target inlet voltage from the at least one subsequent electric vehicle; comparing the target inlet voltage with a voltage of the DC Bus; and connecting the at least one subsequent electric vehicle when the voltage of the DC Bus is appropriately proximate the target inlet voltage, thereby enabling charging or discharging of any connected electric vehicle by subsequent control of the shared DC power converter.

The present disclosure can also be viewed as providing methods of selectively charging one vehicle. In this regard, one embodiment of such a method, among others, can be broadly summarized by the following steps: providing a charging system having: a charging system controller having a processor and computer-readable memory; a shared DC power converter; a DC Bus comprising at least a positive and a negative set of voltage lines; at least two charging dispensers in electrical communication with the DC power converter along the DC Bus, each of the at least two charging dispensers electrically connectable to an electric vehicle; and at least one electric vehicle connected to any of at least two charging dispensers, wherein the at least one electric vehicle is being charged by a voltage of the DC Bus controlled by the charging system controller; attaching a subsequent chargeable vehicle to any available of the at least two charging dispensers; determining that the chargeable vehicle takes charging priority over all of the at least one electric vehicle connected to any of at least two charging dispensers; acquiring a target inlet voltage from the chargeable vehicle determined to have priority; disconnecting at least all connected vehicles incompatible with the target inlet voltage from the chargeable vehicle determined to have priority; adjusting the voltage of the DC Bus to appropriately approximate the target inlet voltage of the chargeable vehicle determined to have priority; and connecting the chargeable vehicle determined to have priority to the DC Bus.

The present disclosure can also be viewed as providing a system for charging an electric vehicle fleet. Briefly described, in architecture, one embodiment of the system, among others, can be implemented as follows. An electric vehicle fleet charging system includes a charging system controller having a processor and computer-readable memory. A DC power converter is included. A DC Bus includes at least a positive and a negative set of voltage lines. A plurality of charging dispensers is in electrical communication with the DC power converter along the DC Bus. Each of the plurality of charging dispensers is electrically connectable to an electric vehicle of an electric vehicle fleet. The charging system controller is configured to: acquire a target inlet voltage requested by a first chargeable electric vehicle of the electric vehicle fleet; acquire a target inlet voltage requested by at least one subsequent chargeable electric vehicle of the electric vehicle fleet; control a voltage of the DC Bus to correspond to the target inlet voltage requested by the first chargeable electric vehicle; and connect any of the first chargeable electric vehicle or the at least one subsequent chargeable electric vehicle of the electric vehicle fleet having a target inlet voltage corresponding to the voltage of the DC Bus, thereby enabling charging of any connected electric vehicle of the electric vehicle fleet.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a diagrammatic illustration of an electric vehicle charging system, in accordance with a first exemplary embodiment of the present disclosure.

FIG. 2A is a diagrammatic graph of the electric vehicle charging system of FIG. 1 in operation, in accordance with the first exemplary embodiment of the present disclosure.

FIG. 2B is a diagrammatic graph of the electric vehicle charging system of FIG. 1 in operation, in accordance with the first exemplary embodiment of the present disclosure.

FIG. 3 is a diagrammatic illustration of a branched electric vehicle charging system, in accordance with the first exemplary embodiment of the present disclosure.

FIG. 4 is a diagrammatic illustration of a simultaneous charge/discharge system, in accordance with the first exemplary embodiment of the present disclosure.

FIG. 5 is a flowchart illustrating a method of charging a plurality of electric vehicles, in accordance with the first exemplary embodiment of the present disclosure.

FIG. 6 is a flow diagram illustrating the method of FIG. 5, in accordance with the first exemplary embodiment of the present disclosure.

### DETAILED DESCRIPTION

Currently, there are two types of systems used for EV charging. In a first type of system, AC voltage is converted to DC voltage within a vehicle being charged, and often referred to as Level 1, Level 2 or AC charging. The second type of system is one where the DC power is directly provided to the vehicle and typically referred to as DC charging.

One issue with AC charging is that the power converter must be carried by the vehicle. This places a limit of size and weight on the power converter and usually limits the amount of power providable to a battery system on a vehicle. DC systems can be as large as needed if off-vehicle space is available, and they have the additional advantage that the onboard power converter can be eliminated—effectively reducing the cost of the vehicle.

Because the charging and discharging process of a battery necessitates that the DC voltage used for the process does not cause an excessive (and damaging) current, the voltage must be controllable within a range near the resting battery voltage. In addition, battery chemistries usually require that regardless of current, a maximum and a minimum battery voltage not be surpassed, thereby requiring careful control of both charging and discharging voltages and currents for each individual vehicle being charged.

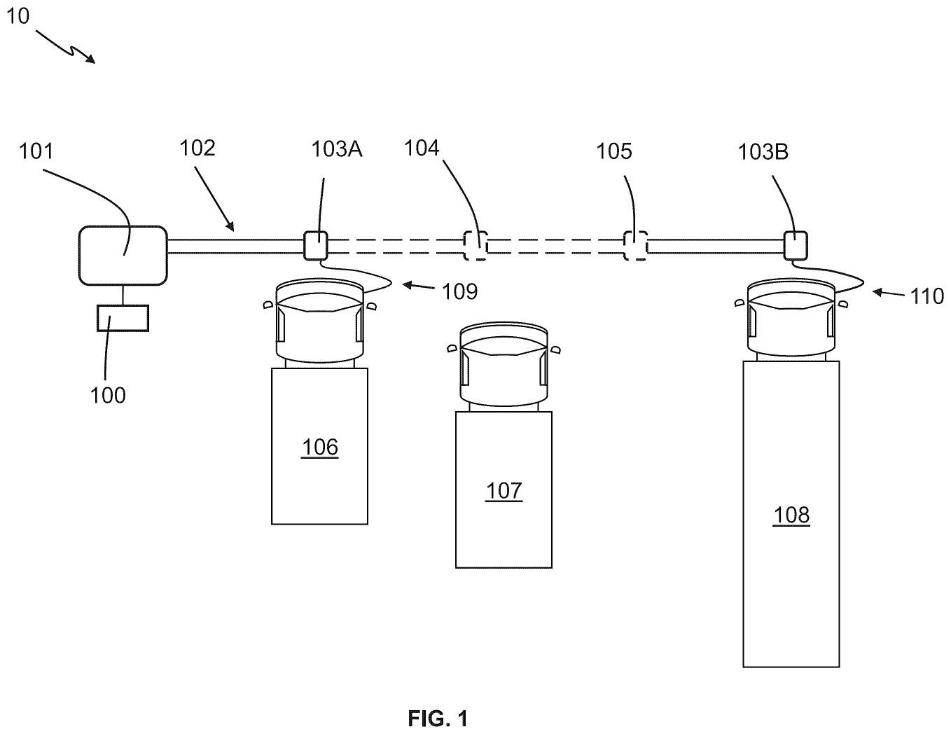

FIG. 1 is a diagrammatic illustration of an electric vehicle charging system 10, in accordance with a first exemplary embodiment of the present disclosure. An electric vehicle charging system (hereinafter, “system”) 10 includes a charging system controller 100 having a processor and computer-readable memory. A DC power converter 101 is included. A DC Bus 102 has at least a positive and a negative set of voltage lines. At least two charging dispensers 103A, 103B are in electrical communication with the DC power converter 101 along the DC Bus 102. Each of the at least two charging dispensers 103A, 103B is electrically connectable to an electric vehicle 106, 107, 108. The charging system controller 100 is configured to: acquire a target inlet voltage requested by a first chargeable electric vehicle 106; acquire a target inlet voltage requested by at least one subsequent chargeable electric vehicle 108; control a voltage of the DC Bus 102 to correspond to the target inlet voltage requested by the first chargeable electric vehicle 106; and connect any of the first chargeable electric vehicle 106 or the at least one subsequent chargeable electric vehicle 108 having a target inlet voltage corresponding to the voltage of the DC Bus 102, thereby enabling charging or discharging of any connected electric vehicle 106, 108 by subsequent control of the DC Bus 102.

As used herein, the term “electric vehicle” may mean any apparatus having a rechargeable battery and connectable to a charging dispenser 103A, 103B, 104, 105. This may include mobile vehicles such as electric cars, trucks, buses, airplanes, trains, trams, all-terrain vehicles, lawnmowers, aircraft, watercraft, and the like. This may also include electronic apparatuses such as generators, mobile devices, toys, battery-operated tools, and the like. For purposes of illustration, the use of “electric vehicle” will generally refer to ground-based vehicles such as cars, trucks, and buses. However, this illustrative usage should not be understood to limit the scope of the disclosure to the examples herein.

As used herein, the term “chargeable vehicle” may mean an electric vehicle with a battery system that has an overlap in all essential charging parameters with the charging parameters providable by the charger described herein and all other essential charging parameters are also within range. A “non-chargeable vehicle” is, at least, one where the battery system has essential charging parameters that do not overlap with the charging system or essential charging parameters that are out of range. It may also be a vehicle that is not attached. For example, a vehicle that requires a minimum of 700V while charging is not a chargeable vehicle for a system that can output a maximum of 600V. A vehicle with a battery at a temperature of 80 C but that requires the temperature to be below 50 C in order to charge is also not a chargeable vehicle.

It should be understood that the scope of the subject disclosure includes charging electric vehicles, i.e., increasing the electric energy stored within the battery for use in operation, and discharging electric vehicles, i.e., decreasing the electric energy stored within the battery for use in operation. For purposes of illustration, the focus of the subject disclosure will primarily be on charging. However, one of skill in the art will understand that the same principles apply to charging and discharging of electric vehicles.

The system 10 has a charging system controller 100. The charging system controller 100 may be any suitable type, number, and form-factor of electronic controllers, including micro-controllers, programmed circuits, linked processors, distributed computing controllers, and the like. In one example, the processing performed by the charging system controller 100 may be performed at least partially local to the system 10. In another example, the processing may be performed at least partially in a distributed computing environment, such as through computers or servers connected over a network connection, an Internet connection, distributed locally, and the like. The charging system controller 100 may have a processor and computer-readable memory, which are not illustrated for simplicity of the disclosure. In one example, the charging system controller 100 may include additional electronic and computer components useful for performing the functions described herein, such as communications hardware, input/output hardware, screens, user interfaces, and the like.

As described herein, the charging system controller 100 may control the operation of the system 10. This may include receiving communications from attached vehicles 106, 108, sending communications to attached vehicles 106, 108, controlling the output voltage supplied by the DC power converter 101 to the DC Bus 102, and the like. In one example, the charging system controller 100 may analyze data received from attached vehicles 106, 108 in order to determine a protocol for charging multiple vehicles 106, 108 over a period of time. This is described in greater detail below.

A DC power converter 101 is included. In one example, DC power converter 101 may be any suitable type, number, and arrangement of DC power converters. The DC power converter 101 may convert source electrical power to a voltage sufficient at least to connect, charge or discharge any chargeable electric vehicles 106, 108. In one example, the source power may include 480V AC in three phases or a DC voltage held in a battery storage system. The source power is not understood to limit the subject disclosure. In one example, the DC power converter 101 may be a single power converter, a plurality of power converters, or a distributed power conversion system. DC power converter 101 may function as a controllable DC source which outputs DC voltage on DC Bus 102 and may optionally also have the capability of converting a voltage on DC Bus 102 and making power available for an external system able to use said power (not shown).

In one example, the system 10 may include a DC power converter 101 having primary DC power converter and a secondary DC power converter. The secondary DC power converter may be a backup, provide additional power or may be operated to provide a different DC voltage to the electric vehicles attached and connected to the system 10, among other uses.

A DC Bus 102 has at least a positive and a negative set of voltage lines. The DC Bus 102 may include any suitable components for transferring electrical power from the DC power converter 101 to the charging dispensers 103A, 103B. The DC Bus may hold a voltage simultaneously presentable at all charging dispensers 103A, 103B, 104, 105 and DC power converters 101 in a system 10. In addition to DC power, the DC Bus 102 may also carry information between charging dispensers 103A, 103B, 104, 105 and the charging system controller 100 by means of a power line communication system. In one example, a separate data Bus may be used to carry communications and other data.

At least two charging dispensers 103A, 103B are in electrical communication with the DC power converter 101 along the DC Bus 102. The charging dispensers 103A, 103B may be any type, number, and form suitable for interfacing with an electric vehicle 106, 107, 108 to create electrical communication between the DC Bus 102 and the electric vehicle 106, 107, 108. The charging dispensers 103A, 103B may include any components typically used to connect with or interface with electric vehicles, including connectors, cables, and the like. In one example, the charging dispensers 103A, 103B may be bidirectional, allowing electrical energy to flow to or from the electrical vehicles 106, 107, 108 as determined by the charging system controller 100. FIG. 1 shows four (4) charging dispensers 103A, 103B, 104, 105. However, it should be understood that the system 10 may include any suitable number of charging dispensers. In operation, the system 10 may include 2 or more, 8 or more, 12 or more 16 or more, or any number of charging dispensers.

Each of the at least two charging dispensers 103A, 103B is electrically connectable to an electric vehicle 106, 107, 108. Electric vehicles 106 and 108 are shown proximate to charging dispenser 103A, 103B and are shown to be attached to the system 10 through charging cables 109 and 110. Electric vehicle 107 is shown further from charging dispenser 104 to illustrate that it is not yet attached to the charging dispenser 104. Electric vehicle 108 is shown larger than electric vehicles 106 and 107, which are both of the same size. This illustrates that electric vehicles may have different charging requirements and parameters; for instance, electric vehicle 108 may contain a larger capacity battery system than the other electric vehicles 106, 107, and this larger battery may operate at a different voltage range.

As used herein, the term “attached” means that the electric vehicles 106, 108 are in communication with the charging dispensers 103A, 103B, and control or communication signals are allowed between the electric vehicles 106, 108 and the system 10. As used herein, the term “connected” means that the inlet of an electric vehicle has electrical communication with DC power source 101 to provide charging or discharging of the electric energy to or from the electric vehicles 106, 107, 108. The number of electric vehicles 106, 107, 108 shown attached to the system 10 is illustrative only and is not intended to limit the disclosure to the examples shown.

In one example, one or more charging dispensers 103A, 103B, 104, 105 may include a vehicle interface, which may include a physical interface such as a charging cable with a connector, and said connector may also include control or communication signals to establish an electronic interface and said signals may be directly connected or through a power line communication system. The vehicle interface may send data to the vehicle and may receive data from the vehicle concerning charging parameters, energy transfer, and the like.

A charging dispenser 103A, 103B may at least interface with an electrical vehicle 106, 107, 108 and may at least obtain information from the vehicle by means of the vehicle interface. In some instances, the charging dispenser 103A, 103B may include a controller, part of a distributed charging system controller, which may be located locally or remotely. The information obtained from any electric vehicle 106, 107, 108 may become available to the charging system controller 100. The charging system controller 100 may determine when any charging dispenser 103A, 103B must connect a DC Bus to the inlet of an electric vehicle 106, 107, 108. A connection past the inlet and into the battery system is controlled by the vehicle, and when this connection is completed, the battery system is in electrical communication with the DC Power source. The connection between the DC Bus and the vehicle's inlet may be either direct or may be indirect with one or more interfacing components. Said interfacing components may include an inline resistor for current measurement, an inline diode, contactors to establish or interrupt power connections, fuses, breakers, ground fault monitoring, galvanic isolation components or controllers, power line communication adapters or any other component that may enhance the functionality and/or safety of the system 10, but that do not significantly modify the voltage level between a DC power converter 101 and the inlet of any connected vehicle 106, 108. Vehicles may include power converters that modify the inlet voltage in order to provide a different voltage to their battery systems, but this description is limited to the scope of a charging system, and thus is limited to providing power at one or more charging vehicle inlets.

The charging dispensers 103A, 103B may connect a charge inlet of an electric vehicle 106, 107, 108 to the DC Bus when the conditions for charging or discharging the electrical vehicle 106, 107, 108 are met, and disconnect the electric vehicle inlet from the DC Bus when the conditions for charging or discharging the electric vehicle 106, 107, 108 are not met—as controlled by a charging program. The present disclosure minimizes the cost of charging dispensers 103A, 103B by eliminating the need of individual power conversion systems for each charging dispenser 103A, 103B. Charging dispensers 103A, 103B may comprise low power high voltage sources useable to emulate some signals typically produced by a power conversion system; however, the low power sources are not involved in the main energy transfer.

Each charging dispenser 103A, 103B of a system 10 must be able to interact with a charging controller of a chargeable electric vehicle 106, 108 that controls the on-vehicle charging process in order to obtain relevant information to be used by the charging program or protocol. Such charging controllers are typically known as Electric Vehicle Communication Controllers or EVCCs, but may include any suitable charger interface. In the art, it is common for an EVCC to be the master of the charging process. In a system 10 where multiple vehicles 106, 107, 108 may share one or more resources (a DC Bus and a DC power source, at least) it is not possible for an EVCC to actually be the master of the entire charging process. This is because every EVCC would compete to establish a charging protocol without knowledge of the requirements of the other attached vehicles.

The charging system controller 100 is configured to acquire a target inlet voltage requested by a first attached or chargeable electric vehicle 106. The charging system controller 100 may be in communication with the EVCC of the first attached or chargeable electric vehicle 106 and may receive an electrical signal communicating the requested target inlet voltage. The target inlet voltage may be the voltage desired by the EVCC at the vehicle inlet for the purpose of commencing a process of charging or discharging. Generally, the target inlet voltage is one that will not cause any critical parameters of a vehicle's battery to be exceeded when an inlet experiencing the target inlet voltage is connected to the vehicle's battery system.

The charging system controller 100 may be configured to acquire a target inlet voltage requested by at least one subsequent chargeable electric vehicle 108. The subsequent target inlet voltage may correspond to required parameters to begin charging the at least one subsequent chargeable electric vehicle 108. In one example, this acquisition may occur at or near the same time as the acquisition of the first vehicle 106's target inlet voltage. For instance, if two vehicles 106, 108 are attached to the system 10 simultaneously, or are attached when the system 10 powers up, then the charging system controller 100 may acquire the target inlet voltage from both vehicles at the same time or one shortly after another. In another example, the first attached or chargeable electric vehicle 106 may provide a target inlet voltage request, and the system 10 may initiate charging of the first chargeable electric vehicle 106 for a period of time. Later, a subsequent electric vehicle 108 may become attached to the system 10 and may issue a target inlet voltage request to the charging system controller 100. This may continue for any subsequent electric vehicles 107 which arrive at the system 10 and attempt to initiate the charging process.

The charging system controller 100 may be configured to control a voltage of the DC Bus 102 to correspond to the target inlet voltage requested by the first chargeable electric vehicle 106 in a charging session, which can include the at least one subsequent chargeable electric vehicle 108 becoming a target vehicle in a new charging session. In one example, a first chargeable electric vehicle 106 may receive electric power from the DC Bus 102 when it is the only vehicle attached to the system 10. When a subsequent electric vehicle 108 arrives, the charging system controller 100 may receive a target inlet voltage request from the subsequent electric vehicle 108 and may either continue to control the voltage of the DC Bus 102 to correspond to the charging or discharging process of first attached or chargeable electric vehicle 106, or may adjust the voltage of the DC Bus 102 to correspond to the subsequent chargeable electric vehicle 108; which may or may not cause vehicle 106 to become disconnected. In addition, the charging system controller 100 may make vehicle 108 wait until the DC Bus is more proximate its charging voltage. It is also possible that a subsequently connected vehicle is not chargeable. If a subsequent electric vehicle 107 should become attached to the system 10, the charging system controller 100 may acquire the requested target inlet voltage of the subsequent electric vehicle 107 and may determine whether to proceed with the existing charging or discharging process, adjust the voltage of the DC Bus 102 to correspond to one or more of the chargeable electric vehicles 106, 107, 108 or make a number of vehicles wait while a number of vehicles proceed to a charging or discharging process.

In one example, “target inlet voltage” may refer to an initial voltage of the DC Bus 102 which must be provided to the electric vehicle 106, 107, 108 in order to connect the electric vehicle 106, 107, 108 for charging. In another example, each electric vehicle 106, 107, 108 may communicate additional requests to the system 10 for a subsequent voltage during the charging process. These additional requests may refer to a “requested charging voltage,” which may be any voltage requested after an initial connection. The system need not honor all these requests.

As used herein, the term “correspond to the target inlet voltage” means that the voltage of the DC Bus 102 is acceptably proximate to the voltage of a requesting chargeable electric vehicle in order to enable connection to the system. In one example and if the vehicle performs no onboard voltage conversion, this may mean that the voltage of the DC Bus 102 is increased or decreased to closely match the voltage of the battery on a requesting electric vehicle. In operation, the voltage of the DC Bus 102 may be adjusted to align sufficiently closely with the target inlet voltage so that charging or discharging may begin for the at least one requesting chargeable electric vehicle.

The charging system controller 100 may also be configured to connect any of the first attached or chargeable electric vehicle 106 or the at least one subsequent chargeable electric vehicle 108 having a target inlet voltage corresponding to the voltage of the DC Bus 102, thereby enabling charging of any connected electric vehicle 106, 108. Once the charging system controller 100 has determined to which chargeable electric vehicle 106, 107, 108 the voltage of the DC Bus 102 will correspond, the charging system controller 100 may connect that particular electric vehicle to begin the charging process. In one example, this may result in only a single electric vehicle 106 being connected and charging. In another example, this may result in a plurality of electric vehicles 106, 108 being connected and charging. In another example, the system 10 may cause one or more connected electric vehicles 106, 108 to become disconnected while connecting a subsequent electric vehicle 107 instead. Therefore, the charging system controller 100 may be further configured to disconnect any of the first chargeable electric vehicle 106 or the at least one subsequent attached electric vehicle 108 if at least their essential charging parameters are expected not to be met when subsequent vehicle 107 becomes connected.

In one example, the charging system controller 100 may be configured to disconnect electric vehicles 106 and 108, adjust the voltage of the DC Bus 102 to correspond to the target inlet voltage of a chargeable vehicle different of the first chargeable electric vehicle 106 or the at least one subsequent chargeable electric vehicle 108 (a vehicle taking charging priority represented by 107) and connect any of the first chargeable electric vehicle 106 or the at least one subsequent chargeable electric vehicle 108 only when their target inlet voltage corresponds to an adjusted voltage of the DC Bus 102. This may allow the system 10 to connect additional electric vehicles represented by 108 for charging, promptly, if they have a high priority. In a further example, the charging system controller 100 is further configured to disconnect any of the first chargeable electric vehicle 106 or the at least one subsequent chargeable electric vehicle 107, 108 having a target inlet voltage not corresponding to an imminent adjusted voltage of the DC Bus 102. For example, if charging electric vehicle 108 causes the voltage of the DC Bus 102 to become too high to enable safe charging of the first chargeable vehicle 106, the first electric vehicle 106 may be disconnected before that event. In another example, if charging or discharging electric vehicle 107 causes the voltage of the DC Bus 102 to become too high or low to enable safe charging of the first electric vehicle 106, but not the second electric vehicle 108, then the first electric vehicle 106 may be disconnected and the second electric vehicle 108 and third electric vehicle 107 may remain connected to continue charging or discharging. If the voltage of the DC Bus 102 should, at another time, correspond to the target inlet voltage of any electric vehicle 106, 107, 108, the charging system controller 100 may be configured to connect any of the electric vehicles 106, 107, 108 at that time. In another example, if the voltage of the DC Bus 102 is slightly higher than the acceptable charging voltage of one electric vehicle 108, the charging system controller 100 may be configured to decrease the voltage of the DC Bus 102 in order to correspond to the charging requirements of more than one electric vehicle 108.

Once the charging system controller 100 is first aware of a target inlet voltage of an electric vehicle 106, 107, 108, it can use this information to make a partial determination of whether the electric vehicle 106, 107, 108 is allowed to charge. Parameters other than the target inlet voltage may be needed to make a full determination of compatibility thereby making a vehicle “compatible”; however, a target inlet voltage that is incompatible with the voltage present at the DC Bus 102 as the system performs a charging or discharging protocol may be sufficient to know that the attempt cannot be allowed and that the electric vehicle 106, 107, 108 may need to wait by pausing their charging process.

If an EVCC does not support a command to be paused indefinitely after providing a target inlet voltage and before connecting to a charging dispenser 103A, 103B, then the charging system controller 100 may instead cause the EVCC to cancel the ongoing charge attempt by use of the vehicle interface (a “charge stop” command is accepted by all standard compliant EVCC); the charging system controller 100 must then be able to cause an EVCC to reinitiate a charge attempt when the voltage of the DC Bus 102 is significantly similar to a target inlet voltage provided by the EVCC in a prior charge attempt.

Depending on the EVCC implementation, an EVCC charge attempt aborted by a charger may require detachment and reattachment of a charging cable 109, 110 from electric vehicle inlet in order to enable a subsequent EVCC charge attempt. A physical detachment of the cable 109, 110 is not practical, but manipulation of a signal or signals that indicate the presence of the cable 109, 110 may convince an EVCC that the cable 109, 110 is no longer attached. Said manipulation of signal or signals may be achieved by removal of power from the signals, by adjustment of voltage or current on the signals, by interruption of the continuity of the signal lines with the adequate number of relays, or by use of semiconductors that increase the impedance in the signal lines to the EVCC or by any other means of interruption of continuity usable in the instance. As long as the system 10 is able to mimic the expected voltages or currents of a detached cable on the signals at the inlet of an electric vehicle 106, 107, 108, an EVCC will assume that the charging cable 109, 110 has been detached even when it is not.

It should be understood that the subject disclosure may be used in operation with any number of vehicles from any setting. In one example, the system 10 may be used in the context of destination charging. In that scenario, electric vehicles driven by multiple independent drivers may come and go to the system 10 at various times, with various types of electric vehicles, and requiring various levels of charging or discharging. In another scenario, the system 10 may be used to charge or discharge a fleet of vehicles owned or operated by one or more related entities. For instance, courier services such as the US Postal Service, Amazon, and the like may direct a plurality of vehicles from their fleets to the system 10 for recharging. Additionally, fleet vehicles such as those belonging to schools, law enforcement, conservation services, manufacturing entities, and the like may be directed to a system 10 for recharging. In this scenario, recharging may occur at one or more periodic times during the day, for instance, after business hours or at the end of a shift. In this scenario, some or all of the electric vehicles in the fleet may be of the same nature and may have the same or very similar charging or discharging parameters.

An electric vehicle fleet charging system includes a charging system controller having a processor and computer-readable memory. A DC power converter is included. A DC Bus includes at least a positive and a negative set of voltage lines. A plurality of charging dispensers is in electrical communication with the DC power converter along the DC Bus. Each of the plurality of charging dispensers is electrically connectable to an electric vehicle of an electric vehicle fleet. The charging system controller is configured to: acquire a target inlet voltage requested by a first chargeable electric vehicle of the electric vehicle fleet; acquire a target inlet voltage requested by at least one subsequent chargeable electric vehicle of the electric vehicle fleet; control a voltage of the DC Bus to correspond to the target inlet voltage requested by the first chargeable electric vehicle; and connect any of the first chargeable electric vehicle or the at least one subsequent chargeable electric vehicle of the electric vehicle fleet having a target inlet voltage corresponding to the voltage of the DC Bus, thereby enabling charging of any connected electric vehicle of the electric vehicle fleet. Charging may begin when the voltage of the DC Bus 102 is increased beyond the connection voltage.

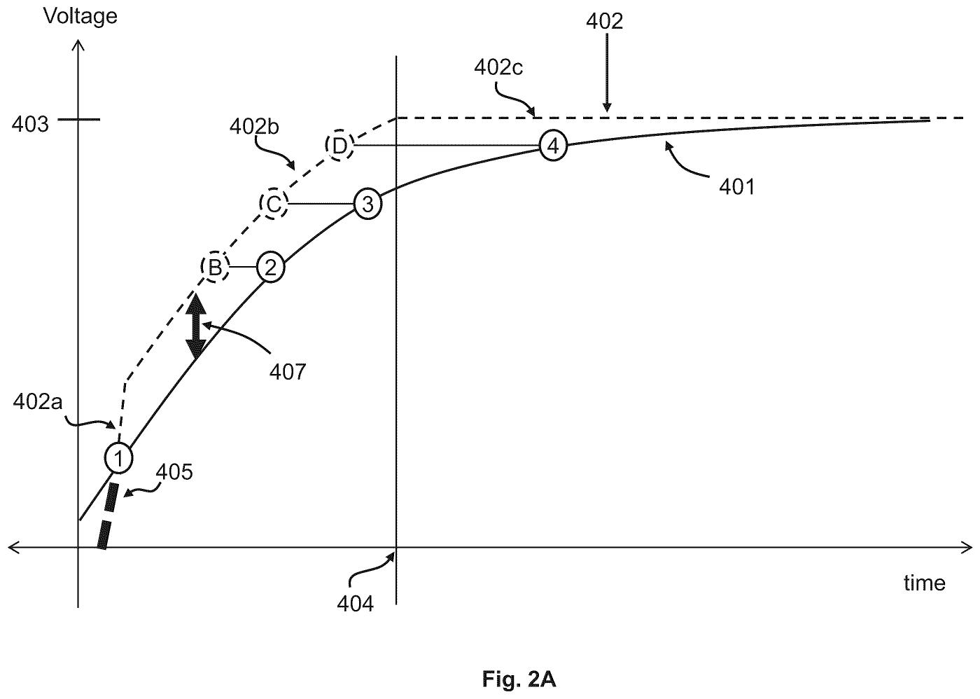

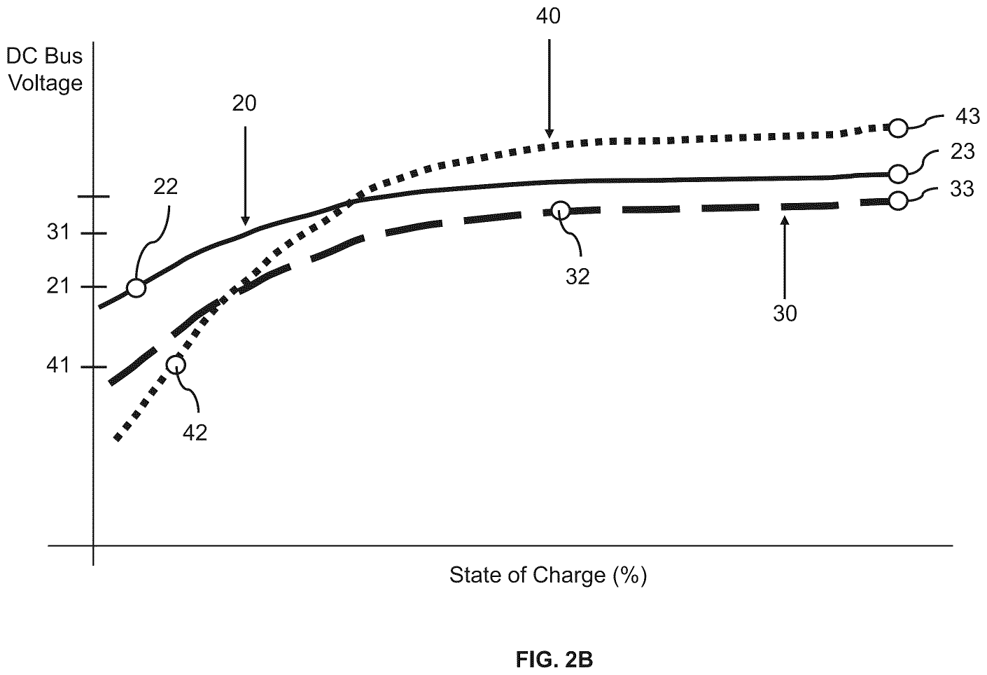

FIG. 2A is a diagrammatic graph of the electric vehicle charging system of FIG. 1 in operation, in accordance with the first exemplary embodiment of the present disclosure. FIG. 2A shows a charging scenario of 4 vehicles, all with very similar batteries. Broken line 402 is shown in three sections, 402a, 402b and 402c and represents the charging voltage applied by a DC power converter 101 to a DC Bus 102 throughout the charging process. Curve 401 shows the resting voltage of a battery similar to one in any of said 4 vehicles. Potential difference indicator 407 shows the constant difference between charging voltage 402b and resting voltage 401. Point 404 indicates the moment when applying a potential difference of 407 to the resting voltage 401 may bring the charging voltage 402 above the maximum battery voltage, shown in tick mark 403. The charging voltage 402 placed by the DC converter on the DC Bus after point 404 is maintained at a level approximate 403, and is represented by 402c.

Solid circles 1, 2, 3 and 4 indicate the resting voltage of the batteries of each of the 4 vehicles. Solid circles 2, 3, and 4 do not represent moments in time. Solid circle 1 shows the moment a first electric vehicle (“vehicle 1”) is connected to the DC Bus 102. Broken line circle B shows the moment a second electric vehicle (“vehicle 2”) joins vehicle 1 on the DC Bus 102. Broken line circle C shows the moment a third vehicle (“vehicle 3”) joins vehicles 2 and 1 on the DC Bus 102. Broken line circle D shows the moment a fourth vehicle (“vehicle 4”) joins vehicles 1, 2 and 3 on the DC Bus. The timing of attachment of vehicles 1, 2, 3 and 4 to their respective charging dispensers 103A, 103B, 104, 105 is not shown, however, it must be assumed that they happened before 1, B, C and D.

The battery curve shown in FIG. 2A does not represent any known battery curve and was chosen simply for readability. The charging profile or charging voltage 402 is also just an example. Every aspect of FIG. 2A has been chosen for ease of explanation. However, one versed in the art will recognize the simplified analogy to actual battery chemistries.

In FIG. 2A, vehicle 1 is connected when the charger rapidly adjusts the voltage of the DC Bus 102 to approximate vehicle's 1 requested inlet voltage, as shown by thick broken line 405. Once vehicle 1 is connected, the voltage of the DC Bus 102 may be increased to enable a maximum current to flow into vehicle 1, as shown in 402a. Once the current limit of the battery is achieved, the voltage may increase no further, and in this example shall follow curve 402b. At point B, the charging voltage of vehicle 1 will approximate the resting voltage of vehicle 2, which in turn may allow vehicle 2 to connect. Vehicles 1 and 2 will approximately follow curve 402 until they reach the resting voltage of vehicle 3, at which point vehicle 3 may join the charging session. Likewise, if all parameters to allow vehicle 4 to charge are met, vehicle 4 may join the charging profile at point D. As is shown in this example, any and all vehicles able to charge will have connected during the constant current phase of the charging, which happens before point 404.

This is a simplified example. There are many practical applications where the voltage curves of the batteries of attached vehicles will not match closely, and in such cases, a charging voltage analogous to 402 must follow the most restrictive charging curves as they become present. This will happen unless the charging system decides that the restrictions of one charging curve are too onerous and drops a restrictive vehicle from the charging session for it to be charged later.

FIG. 2B is a diagrammatic graph of the electric vehicle charging system 10 of FIG. 1 in operation, in accordance with the first exemplary embodiment of the present disclosure. FIG. 2B illustrates an exemplary charging process of three attached vehicles which may be charged by the system 10. When compared with FIG. 2A, it is immediately noticeable that whereas all four vehicles in FIG. 2A followed the same charging curve 402, the vehicles in FIG. 2B each have distinct charging curves 20, 30 and 40. Also when compared with FIG. 2A, which shows trend lines or charging voltage curves represented over time, FIG. 2B shows charging voltage vs battery system SOC. This distinction, as well as the removal of the resting voltage reference has been done for simplification (with four vehicles, each with distinct curves, a graph as of FIG. 2A becomes difficult to follow). The choice of voltage vs SOC rather than voltage vs time allows imagining circles 22, 32 and 42 moving along charging curves 20, 30 and 40 without the need for said circles to remain aligned on the X axis.

Each vehicle has an initial state of charge shown by 22, 32, 42, respectively, viewed as a percentage of each vehicle's battery capacity. The state of charge 22, 32, 42 corresponds to a target inlet voltage of the DC Bus 102, which is indicated by tick marks 21, 31, 41, respectively. As the state of charge of each vehicle increases, the required voltage of the DC Bus 102 to continue providing a charge increases commensurate with the trend lines of the graph. Trend line graphs 20, 30 and 40 are idealized; a more realistic behavior would show a slight voltage increase after their respective battery systems are connected to the DC Bus in order to force a charging current into said battery system. The simplified representation, however, is simpler to follow.

In operation, the system 10 may begin charging any vehicle first. In the example shown in FIG. 2A, the charging system controller 100 may be configured to begin charging the vehicle having the lowest target inlet voltage, which is electric vehicle with charging curve 40. The voltage of the DC Bus 102 may be increased or decreased to correspond to the target inlet voltage 41 of the corresponding vehicle, which is to say that the voltage may be a tolerable voltage close to the target inlet voltage 41. The system 10 may begin charging the electric vehicle with charging curve 40. The voltage of the DC Bus 102 may increase as the state of charge 42 of the electric vehicle with charging curve 40 increases according to the charging curve.

During operation, the voltage of the DC Bus 102 may increase to correspond with the target inlet voltage 21 of the electric vehicle with charging curve 20. At that point if it is within the parameters of both vehicles with curves 20, 40, electric vehicle with charging curve 20 may be connected to the system 10 for charging, and both vehicles with charging curves 20, 40 may be charged simultaneously. As the state of charge 22, 42 of each vehicle increases, the voltage of the DC Bus 102 may increase in a corresponding manner and each vehicle will follow its own charging curve or trend line; only the Y axis is necessarily common

In the example shown in FIG. 2A, the voltage of the DC Bus 102 may increase to correspond to the target inlet voltage 31 of the remaining electric vehicle with charging curve 30. Now all three vehicles may be connected to the DC Bus 102 for charging as all vehicles have points on their respective curves that match voltage 31. As charging curve 30 has a relatively flat slope at higher states of charge, electric vehicle with charging curve 30 reaches a completed state of charge 33 at a lower voltage than electric vehicles with charging curves 20, 40. When electric vehicle with charging curve 30 has reached a complete state of charge 33 (the battery is at full capacity), it may be disconnected from the DC Bus 102.

At that point, electric vehicles with charging curves 20, 40 may remain connected and requiring further charge. The charging system controller 100 may determine a voltage of the DC Bus 102 suitable for charging one or both electric vehicles with charging curves 20, 40, as there is an overlap remaining in their charging voltages. In the example shown in FIG. 2B, the charging system controller 100 may rather decide to disconnect electric vehicle with charging curve 20 from the DC Bus 102 in order to continue charging electric vehicle with charging curve 40. Once electric vehicle with charging curve 40 has reached a completed state of charge 43, said vehicle with curve 40 may be disconnected from DC Bus 102. The voltage of the DC Bus 102 may be adjusted downward to correspond to the target inlet voltage of the electric vehicle with charging curve 20, and electric vehicle with charging curve 20 may be reconnected to the DC Bus 102.

Charging of the electric vehicle with charging curve 20 may resume until electric vehicle with charging curve 20 reaches a completed state of charge 23. As mentioned previously, charging curve 20 is idealized. In a non-idealized curve, vehicle with curve 20 would see a slight voltage drop as it is disconnected, and would settle below curve 20 even at the same SOC.

Other variations of this charging protocol are considered within the scope of the disclosure, and are described herein.

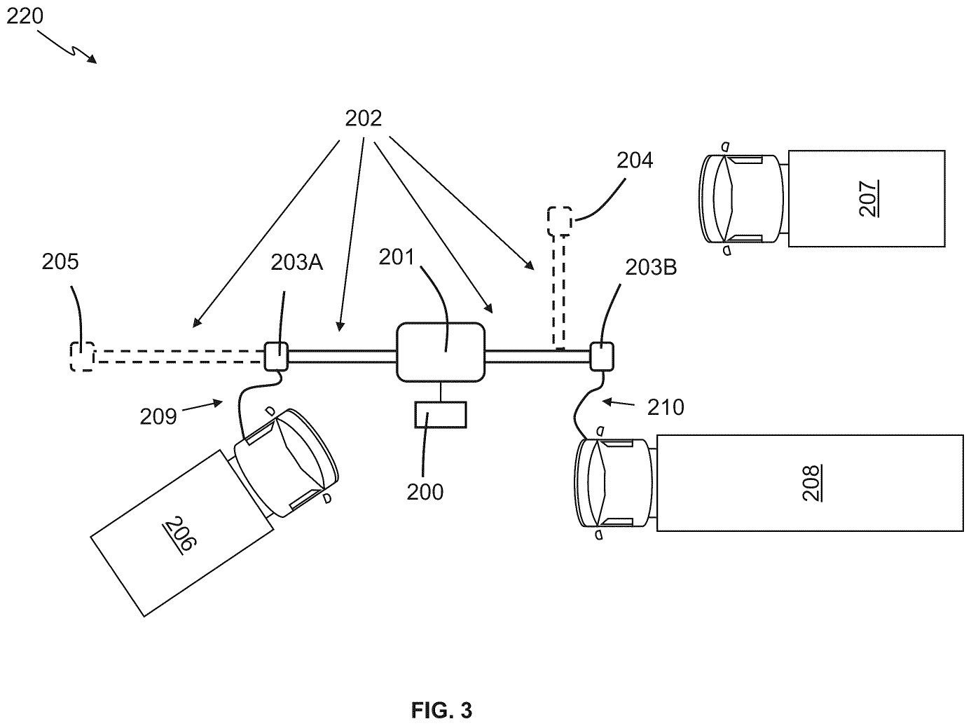

FIG. 3 is a diagrammatic illustration of a branched electric vehicle charging system 220 (“charging system 220”) in accordance with the first exemplary embodiment of the present disclosure. The charging system 220 of FIG. 3 may include the same components of FIG. 1 arranged in a different topology, including a charging system controller 200, a DC power converter 201, a DC Bus 202, charging dispensers 203A, 203B, 204, 205, electric vehicles 206, 207, 208, and charging cables 209, 210.

The topology of the DC Bus need not be configured in a straight line and may even have branches as shown in FIG. 3. As long as a set of voltage potentials across any number of sections of conductors are determined by the output of DC power converter 201 during a charging protocol, or the voltage potential at the DC power converter 201 is determined by the battery voltages of the combined connected vehicles 206, 208, minus any minor voltage drops, when in discharging protocol or session, then any the sections with voltages primarily determined by a same DC voltage source (or sources) are said to be part of the same DC Bus 202.

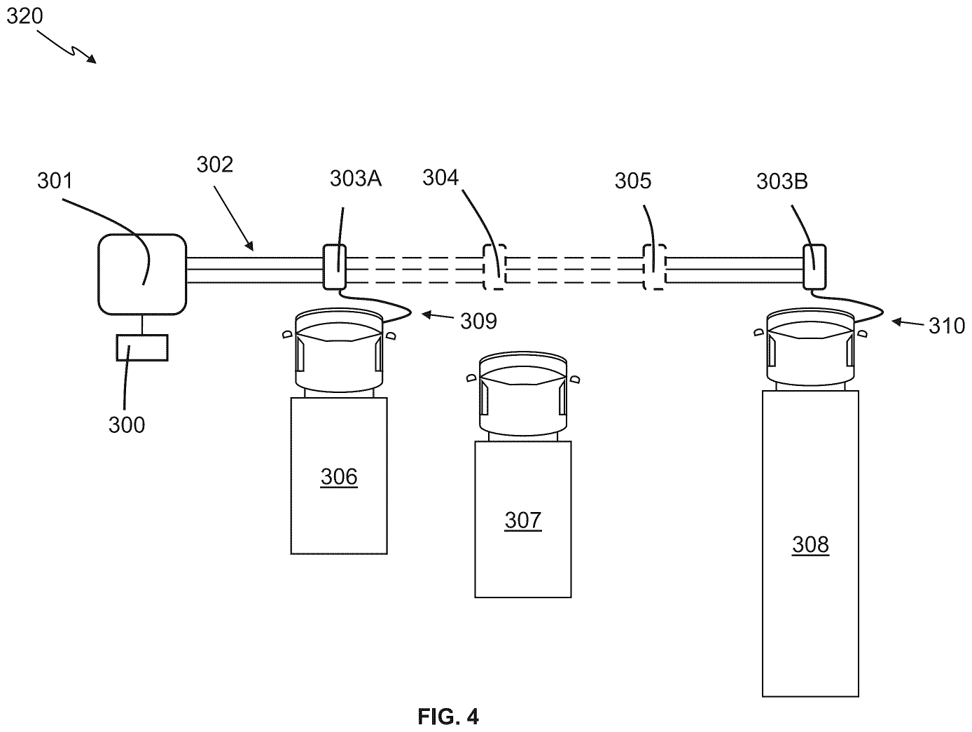

FIG. 4 is a diagrammatic illustration of a simultaneous charge/discharge system 320 (“charge/discharge system 320”), in accordance with the first exemplary embodiment of the present disclosure. FIG. 4 may include the same components of FIG. 1 arranged in a different topology, including a charging system controller 300, a DC power converter 301, a DC Bus 302, charging dispensers 303A, 303B, 304, 305, electric vehicles 306, 307, 308, and charging cables 309, 310.

The charge/discharge system 320 may further include an additional voltage potential running through the system DC Bus 302, which is illustrated by having three voltage lines, where the third line may represent a second positive line or represent a fully independent, second, DC Bus with its own negative line. This additional independent voltage potential may allow certain electric vehicles 306 to be in a charging state while other electric vehicles 308 are in a discharging state as long as the DC power converter is able of using said additional independent voltage. In one example, the DC converter may be connected to a second DC Bus which in turn is connected to at least one charging dispenser 303A, 303B, 304, 305 in the charge/discharge system 320. The DC power converter 301 may then be driven by the charging system controller 300 in charging mode for one or more vehicles 306 connected to a first DC Bus, and a charge program in discharging mode for a group of vehicles connected to the second DC Bus. When no vehicles are being discharged, the same system may instead use the additional DC Bus line or Bus to place a second positive DC Bus voltage in order to create a second group of vehicles that can be independently charged. Using said independent voltage to produce an additional positive DC voltage requires said power converter to be able to generate said second independent voltage. Charge dispensers 303A, 303B, 304, 305 need not be connected to one DC Bus or the other, and may (preferably) make a vehicle connectable to either. This configuration is equivalent to two charging systems, as described herein, that share DC power converter 301 and parts of one, some or all charge dispensers. Such system 320 is shown in FIG. 4, where when compared to FIG. 1 it can be observed that a resulting combined system with two DC Buses would be able to simultaneously charge one or more vehicles while also discharging one or more vehicles. Such system 320 is able to balance the voltages across a fleet of vehicles with a possible purpose of exporting the maximum amount of energy at the maximum amount of power. Such system 320 is also able to charge two groups of vehicles at distinct DC Bus voltages. Other uses are conceivable.

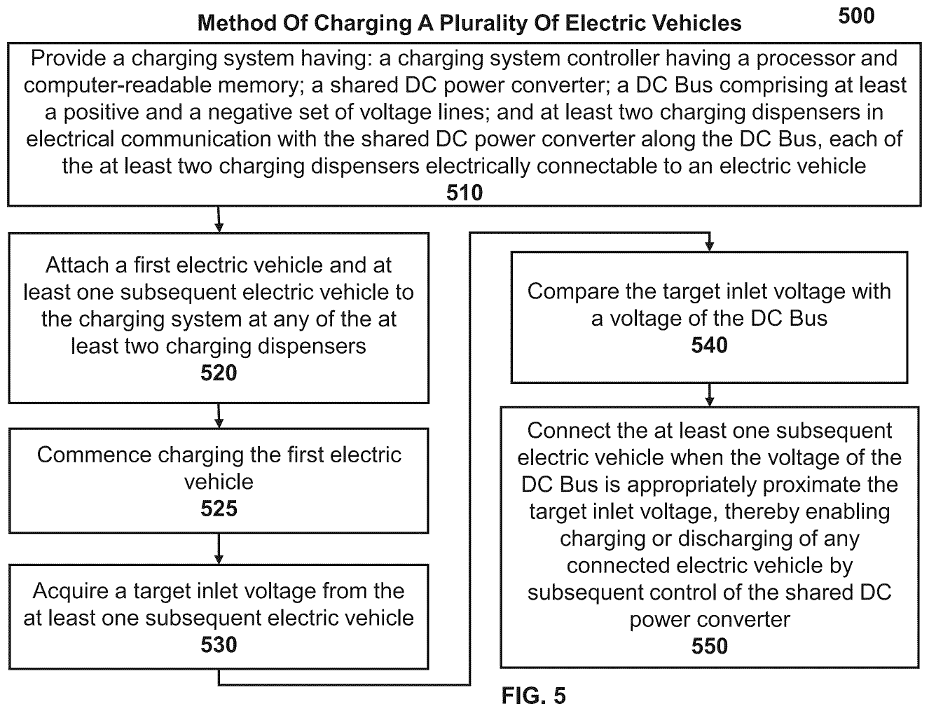

FIG. 5 is a flowchart 500 illustrating a method of charging a plurality of electric vehicles, in accordance with the first exemplary embodiment of the present disclosure. FIG. 5 may be understood with reference to FIGS. 1-4, above.

It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

Step 510 includes providing a charging system having: a charging system controller having a processor and computer-readable memory; a shared DC power converter; a DC Bus comprising at least a positive and a negative set of voltage lines; and at least two charging dispensers in electrical communication with the shared DC power converter along the DC Bus, each of the at least two charging dispensers electrically connectable to an electric vehicle.

Step 520 includes attaching a first electric vehicle and at least one subsequent electric vehicle to the charging system at any of the at least two charging dispensers.

Step 525 includes commencing a charging process of the first attached vehicle. For the first vehicle connected, the relationship with the DC power converter is one-to-one and initiation of the charging process can be achieved with conventional techniques, similar to that of a traditional charger.

Step 530 includes acquiring a target inlet voltage from the at least one subsequent electric vehicle.

Step 540 includes comparing the target inlet voltage with a voltage of the DC Bus.

Step 550 includes connecting the at least one subsequent electric vehicle when the voltage of the DC Bus is appropriately proximate its target inlet voltage, thereby enabling charging or discharging of any connected electric vehicle by subsequent control of the shared DC power converter.

It is noted that any additional steps may be included, including steps directed to controlling a voltage of the DC Bus to correspond to the target inlet voltage requested by a first chargeable electric vehicle in order to connect it and commence charging. In another aspect, the method 500 may include further configuring the charging system controller to control the voltage of the DC Bus to correspond to other parameters. In order to charge a vehicle, the DC Bus may not remain at the resting voltage of the battery, it must be increased to cause a flow of current and a resulting accumulation of energy in all connected battery systems. The main parameters that must be controlled in the charging process of each battery are the maximum current and the maximum voltage. In a system as of this disclosure, all connected vehicle battery systems can be viewed as a single distributed battery system. Naturally the system must ensure at least that none of the maximum currents or maximum voltages of any of the batteries are exceeded, and thus the voltage on the DC Bus is controlled so that all battery systems that comprise the single distributed battery system remain within acceptable parameters. Another consideration working in the control of the DC Bus voltage may include ensuring not to exceed a predefined total system power, which may be a limiting factor of the DC Power Converter or of the electrical utility feeding the system. Batteries may overheat with excessive current; an example of a limiting parameter may be holding current low on some battery systems until they have cooled. In an example mostly applicable to the system herein described, the DC Bus may be held steady at the requested inlet voltage of a vehicle that is in the process of being connected. This is not to be confused with the system aiming for the target voltage of the connecting vehicle, but simply the system courteously holding the voltage it automatically reached while the vehicle joins the charging process. Once any newly connected vehicle joins the charging process, the battery system of said vehicle also shares limiting parameters that will be taken into account in the controlling of the DC Bus voltage.

In one aspect, the method 500 may include the step of sending, by the charging system controller, signals to at least one of the charging dispensers to communicate to the electric vehicle attached thereto that the chargeable electric vehicle has been paused, then unpaused.

In another aspect, the method 500 may include the step of changing, by the charging system controller, the voltage of the DC Bus to correspond to a changed charge state of at least one connected electric vehicle. The change in the voltage of the DC Bus may be either an increase in the voltage of the DC Bus, corresponding to an increased charge state or a decrease in the voltage of the DC Bus, corresponding to a decreased charge state.

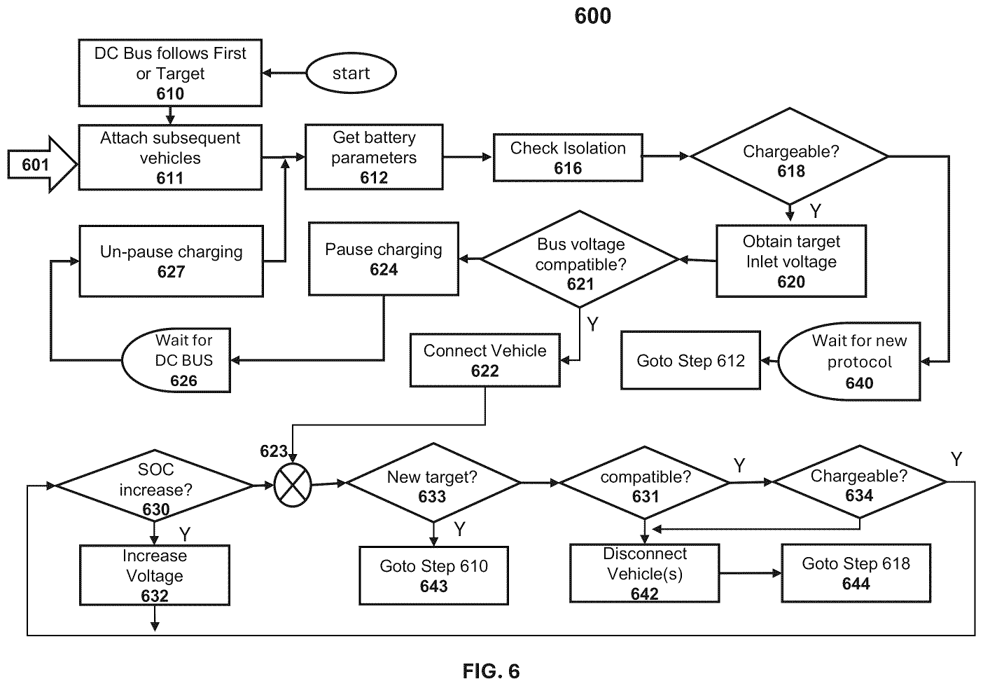

FIG. 6 is a flow diagram 600 illustrating the method of FIG. 5, in accordance with the first exemplary embodiment of the present disclosure. FIG. 6 may be understood with reference to FIGS. 1-5, above.

Step 610 shows that the charging voltage of the DC Bus will be adjusted to a first connected chargeable vehicle or a subsequently connected target vehicle, which may be determined according to any suitable protocol or set of values and parameters. In one example, one or more protocols may be implemented during a period of time or during a single electric vehicle's charging cycle. For instance, a first charging protocol may be implemented at the outset of charging a single electric vehicle. If multiple subsequent electric vehicles become attached and attempt to charge, a different protocol may govern the charging of all of the electric vehicles. In another example, a charging system may implement one type of protocol at certain times—business hours, peak volume hours, peak cost hours, and the like—and may implement a different type of protocol at other times.

Exemplary charging protocols, also known as charging programs, are discussed below. For the purposes of simplification, the terms ‘compatible vehicle’ and ‘target vehicle’ are used in the descriptions. A compatible vehicle is a chargeable vehicle which at least has a target inlet voltage very proximate to the Bus voltage. A protocol or charging program may include other parameters that need to be met for a vehicle to be charged, and said parameters also define a compatible vehicle. A target vehicle is the electric vehicle for which the voltage of the Bus may be purposefully adjusted (and not just as the result of the charging or discharging process of other vehicles) in order to enable its prompt connection to the DC Bus. A target vehicle takes priority and in practice is very similar to a first chargeable vehicle; the main difference is that upon connecting a target vehicle, other vehicles may remain connected.

These exemplary charging programs are meant to be illustrative only, and do not limit the scope of the subject disclosure.

### FIFC Program

In a First In, First Charged (FIFC) charging program example, a target vehicle is any chargeable vehicle that was earliest attached to the charging system. Subsequent attached vehicles having different target inlet voltages may be queued for charging until the earlier-attached vehicles have completed charging. While the directive of an FIFC program may be to charge a vehicle earliest connected to the charging system, it may also allow the charging system to pick up any chargeable vehicles that become compatible vehicles as the voltage of the DC Bus rise. In one example, when a first electric vehicle is fully charged, several other vehicles may have also achieved full charge as well. A new target vehicle is thus not necessarily one that was connected immediately after a previous target vehicle.

### FCCB Example

In one example, a flat curve common battery (FCCB) may be used in operation. Some battery chemistries exhibit a very flat voltage curve across a wide range of state of charge, in such cases it is possible for a charging program to select a common DC Bus voltage compatible with all attached vehicles across the range, even if this does not induce the maximum current in some vehicles. In fleets of vehicles that use a common battery type, if the battery has a flat charging curve as described, then vehicles at a wide range of state of charge may be compatible vehicles. A newly attached vehicle's battery system will, however, not be at the charging voltage but rather at its resting voltage. In a charging program that is unaware that a newly connected vehicle could be made ready to charge, the newly connected vehicle may be made to wait for all other vehicles to complete their charge before beginning charge. In the FCCB charging program, the range of state of charge that can make a particular vehicle compatible with the currently charging or discharging vehicles is known by the system and may, for example, temporarily interrupt charging of all currently connected vehicles (by disconnection or by lowering the DC Bus voltage) in order to connect the newly attached vehicle. A short interruption to connect a newly attached vehicle may be the preference of the charging system. Lithium Iron Phosphate is a chemistry that exhibits such flat voltage range across a state of charge, and is a very popular battery in electric vehicles due to its safety. In practice the FCCB protocol is the same as a FCFC protocol with the caveat that the only compatible vehicles are those with a common battery system.

### LVFC Example

In a Lowest Voltage First Charged example (LVFC) the target vehicle may be, at least, the chargeable electric vehicle with the lowest voltage. As the voltage on the battery systems of all electric vehicles being charged begins to rise, the DC Bus may reach a voltage level sufficiently similar to the voltage of the battery systems of one or more vehicles awaiting to be charged. In effect, a LVFC system “picks up batteries on the way up” and may charge several electric vehicles concurrently—possibly eventually charging all vehicles.

A properly implemented LVFC program is not limited by battery systems of different voltage ranges. For example, if the maximum battery system voltage of a first target vehicle is 400V and the minimum battery system voltage of a waiting vehicle is 548V, then a properly implemented LVFC program may charge all vehicles compatible with the target vehicle first and then continue to charge the waiting vehicle at some point.

An LVFC program may be used with electric vehicle fleets where the electric vehicles are similar. This may allow the charging system to leverage the homogeneous characteristics of the batteries. In another example, a FCCB program may be a better approach if the battery systems are identical.

### LCFC Program

In a low charge, first charged program (LCFC) the charging system controller may target a vehicle with a battery system that has the lowest state of charge, regardless of the voltage required to charge the battery system. In this example, a chargeable electric vehicle having a state of charge of 5% capacity would receive priority in the charging protocol over a chargeable electric vehicle having a state of charge of 50% capacity. In one example, the charging system may continue charging the target vehicle until it has achieved a complete state of charge. In another example, the charging system may charge the target vehicle until it has achieved a threshold state of charge, for instance, 50% capacity. Then, the charging system may begin charging a different vehicle below the threshold state of charge by making it the new target vehicle. The threshold state of charge may be any suitable amount of capacity. In one example, the threshold state of charge may be different for different vehicles. For instance, electric vehicles having a smaller capacity battery may be charged to a higher threshold capacity before being disconnected. Electric vehicles having a larger capacity battery may be charged to a lower threshold capacity before being disconnected. In another example, the LCFC program may fully charge a target vehicle before targeting a different vehicle.

While the LCFC example aims to charge a vehicle with the lowest state of charge, it may also pick up any vehicles that become compatible for charging as the voltage of the DC Bus rises. It is possible, thus, that vehicles with higher state of charge than ones that are waiting vehicles become compatible vehicles and are charged first. Since it is possible for two or more electric vehicles to have the same level of charge at different voltages, the charging program may include additional parameters for determining a target vehicle. Said parameters may prevent alternating between two or more target vehicles as one gains more charge over others.

An LCFC program may be useful for situations where the battery systems of electric vehicles are of diverse types, and particularly in remote areas where having a sufficient state of charge is more critically important.

### LIFC Program

In a Last In, First Charged (LIFC) program, a target vehicle is one that was most recently attached to the charging system. In order to implement an LIFC example, a charging system controller may keep track of the order in which vehicles have been connected to a charging dispenser. While an LIFC prioritizes the last connected vehicle it may also pick up any vehicles that become compatible vehicles as the DC Bus rises. It is possible, thus, that vehicles that were connected much before other waiting vehicles become compatible vehicles and are charged first.

### SRFC Program

A Shorter Range, First Charge (SRFC) program may consider the current travel range of the vehicle to select the target vehicle. In operation, an attached vehicle having the shortest travel range may become a target vehicle first. In one example, the charging system may target a vehicle having the next shortest travel range to be charged subsequently, and so on. In another example, vehicles may be charged to a threshold minimum range, and the program may select a subsequent vehicle below the threshold, until all vehicles meet the threshold requirements. In another example, vehicles having a travel range below a threshold, for instance, below 25 miles, may be charged first. If no vehicles have a travel range below the threshold, the SRFC program may default to another charging protocol.

The range of a vehicle may be estimated by a controller on a vehicle based on the vehicle's battery system state of charge and by its usage history. If this information may not be available to the charging dispenser, the charging controller needs to be able to identify a vehicle connected to a charging dispenser and hold a database of one or more characteristics for the identified vehicle. Some options for vehicle identification are license plate readout, RFID tags and optical recognition among others. Modern charging interfaces include the ability to report vehicle identification or even MAC addresses of connected controllers, and when this information is available, external identification methods may not be necessary.

### HVFD Program

A High Voltage, First Discharge (HVFD) program makes the compatible vehicle with at least the highest voltage the target vehicle and then initiates a discharge process whereby energy stored on the battery systems of connected electric vehicles is made available for a DC power converter to provide to an external system. As the voltage is lowered during the discharge process, other battery systems may become connected. An HVFD system be particularly useful where there are no minimal power requirements in an external system that may use the available energy. It is possible, however, that an HVFD example may initially connect only one electric vehicle with a battery system unable to supply the power required by an external system that does have minimal power requirements.

### TPFD Program

A Target Power First Discharge (TPFD) program makes the target vehicle one that, combined with sufficient compatible vehicles, is able to provide a minimum power, said power target may be set to support the power requirements of an external system. As the energy on the compatible vehicles is delivered to the External system the voltage of the DC Bus will drop. Said drop may make other vehicles compatible vehicles and as long as the combined available power is sufficient to meet the set power target the system may continue to provide energy. Said target power may be variable throughout the discharging process.

### Balancing Charging Program

A balancing charging program aims to configure the voltage across a set of chargeable electric vehicles. If the voltages of battery systems of a set of electric vehicles attached to a charging system are significantly similar, it is possible to simultaneously connect any vehicle within the set to a same DC Bus as long as it also meets all other requirements to become a compatible vehicle. A program where several electric vehicles are ready to connect simultaneously may become a more reliable system for power delivery to an external system. Some energy may be lost in the process of moving energy between the battery systems of different vehicles, but a more consistent and predictable availability of power may be achieved.

A balancing charging system may choose a set that includes all vehicles, or may select multiple sets where the battery systems of the vehicles have a similar voltage range. An aim of a balancing charging system example may be the delivery of constant power during a discharge process, in which case the total current available from all connected battery systems, multiplied by the instantaneous DC Bus voltage, must always exceed the required target power. In a guaranteed power configuration, it may be a waste to equalize the voltage across a single set of all available vehicles, instead, setting up a fleet of chargeable electric vehicles in which voltages are staggered can achieve an increase in available current which adequately compensates the DC Bus voltage drops.

In step 611 a subsequent vehicle is attached. In step 612, the charging system controller may begin the process of obtaining essential charging parameters of the battery system of an attached vehicle. This may include receiving data communications from an attached vehicle to determine how to begin charging said attached vehicle. Example charging parameters may include battery maximum and minimum voltages, maximum current, maximum power, battery state of charge information, temperature information (if available), and the like. In step 616, the charging system controller may perform a check to determine the integrity of the charging cable. The charging system controller may perform additional safety checks as necessary. In step 618, the charging system controller may analyze the parameters to determine whether an attached electric vehicle is of a type that may be charged and is in appropriate condition for charging; this includes the information obtained regarding the charging cable integrity. In the event that an attached vehicle is not chargeable, the vehicle will be disregarded in step 640 until a new charging protocol becomes effective. In another example, a vehicle may be deemed not chargeable by the parameters obtained in 612 alone, and may be disregarded before executing an isolation check. Step 620 includes obtaining the target inlet voltage of a vehicle connected at step 611.

Vehicles connected in step 611 may include fleet vehicles being attached simultaneously or substantially simultaneously at a point in time. Upon attachment of the one or more subsequent electric vehicles, steps 612-620 may be followed to prepare the one or more subsequent electric vehicles for charging.

In step 621, at least the target voltage of a connected vehicle is compared to the DC Bus voltage. In step 624, any vehicles which are not yet to be charged may receive communications from the charging system controller that may indicate to the EVCC that the vehicle's charging process has been paused. When a vehicle does not support a pause command, it is possible instead to stop the charging process and make the vehicle believe that it has been detached from the charge dispenser. In reality, a physical detachment may not take place; this signal is merely to satisfy the need of some EVCC to receive a detachment notice when charging does not begin quickly in order to allow a subsequent charging session to commence. When the DC Bus voltage does correspond to the target inlet voltage of a waiting vehicle, as determined in step 626 the process flows to Step 627, unpausing the charging process and in a common case, emulating an attachment to the system.

In step 622, any one or more electric vehicles that are suitable for charging with the voltage on the DC Bus may be connected to the charging system in order to join the charging or discharging process.

Steps 611-622 and steps 624-627 represent actions upon individual vehicles, summing junction 623 is included to indicate that said individual vehicles are added to the charging process that follows.

Step 630 and Step 632, combined, include continuing the charge to the one or more electric vehicles which are attached and connected to the charging system. As the batteries of the one or more electric vehicles reach higher states of charge, the voltage of the DC Bus required to maintain a positive rate of charge may increase. The charging system periodically monitors the charging parameters of the entire system. In step 630 the system monitors the effect of the Bus voltage on the SOC rate of increase, which in step 632 may increase the voltage on the DC Bus to maintain a positive rate of charge of the one or more vehicles. The voltage increase is, of course, limited to the maximum voltage of any connected battery.

During a charging process, a charging system may increase the voltage on the DC Bus above the resting voltage of connected electric vehicles, causing current to flow into the battery systems of the connected electric vehicles. As the charging program charges vehicles concurrently, it may ensure that no critical charging parameter of any battery system is exceeded. For example, the maximum charging current of one battery system may be 100 A while the charging current of another battery system may be just 80 A; in such case, the charging program may control the DC power converter output voltage onto the DC Bus such that neither of these currents are exceeded. In this example, the same DC Bus voltage may cause different charging currents into different battery systems. The system must ensure that the current going into each battery system does not surpass a maximum value per battery system. Some critical battery system parameters are limiting of other battery systems. For example, one first battery system may have a maximum voltage of 420V and a maximum charge current of 80 A, whereas a second battery system may have a maximum voltage of 380V and a maximum charge current of 100 A. In the example the DC Bus voltage may not exceed 380V as long as second battery is connected, even if neither battery system is charging at its maximum current.

At any point in this process, a subsequent vehicle may be attached to the charging system. This is denoted by symbol 601. Therefore, the process may include the recursive step of attaching subsequent vehicles (step 611), and any of steps 612-622 and 624-627 as are required.

Steps 631 and 634 combined with step 642 include stopping the charge process of one or more vehicles. In one example, charging may be stopped because the electric vehicle has reached a maximum state of charge, as determined by a controller of the vehicle, the EVCC, or other controllers (step 634 and 642). In another example, the charging may be stopped because the electric vehicle has reached a sufficient state of charge as determined by a charging protocol or the user of a vehicle (step 631 and 642). In another example, the charging system may determine that it is preferable to stop charging one or more vehicles and begin charging one or more other vehicles (step 633 and 643). In step 642, one or more vehicles may be disconnected from the DC Bus and may not be allowed to receive a charge. As decided in step 618, this disconnection may be either temporary, if the electric vehicles will be receiving a charge in turn, or may be permanent, if the electric vehicles have become non-chargeable, in which case the vehicle may end up in step 640 waiting for a new charging protocol.

At any point in this process, a subsequent vehicle may be attached to the charging system, as shown by arrow 601. Therefore, the process may revert to step 611 and any of steps 612-627 as are required.

In a discharging configuration, the DC Converter does not place a voltage on the DC Bus, but rather consumes a current from said DC Bus causing any connected batteries to lose SOC. The voltage on the DC Bus in a discharge process is determined by the connected batteries. If the SOC becomes too low, as configured, a vehicle will become not further dischargeable. Step 634 monitors the discharging parameters and ensures safe disconnection of a vehicle when appropriate with steps 642 and 644. Steps 612-627 are equally applicable for a discharging process when step 618 also checks for the condition of dischargeable. In a discharge process, 630 monitors the power provided instead and step 632 pulls more current as needed.

Several examples of the charging programs have been described above, each with advantages for particular situations or applications. One particular example of the charging program may include the ability to configure multiple alternative charging sessions, where an individual charging session allows the configuration of parameters (other than essential charging parameters) that describe a compatible vehicle and a target vehicle, in other words, a charging protocol. Conditions for transitioning between the charging sessions may also be defined, or a sequence of the charging sessions may be fixed and executed in turn as each session completes the charging of target vehicles. Charging sessions may be repeated in a charging sequence, and the lack of target vehicles may not be the only condition used to transition between them. Charging sessions may also not follow a pre-established order, and may rather be executed by the availability of target vehicles or even by the time of day or any other configurable parameter. Charging sessions may be prioritized so that when more than one charging session has a potential target vehicle, a higher priority charging session is executed. For example, a minimum range session may have priority over all others, which may include a minimum state of charge session. If two vehicles can do 100 miles at different SOC, then the program may run the session that makes both vehicles first have 100 miles. After that session is over, both vehicles may continue to charge until a particular state of charge. However, if a third vehicle arrives and attaches to the system with a range less than 100 miles, that session may take priority and thus that third vehicle becomes the target vehicle. Charging sessions may also be configured to be able to interrupt other sessions. In one example of the charging program, any vehicle that is capable of being charged within two or more types of charging sessions need not be disconnected from the charging system during the transition from one session to the other.

One example is that of a car dealership where the highest priority is to have all electric vehicles always ready for a test drive, and it may also be desirable, as a courtesy, to offer a 10% energy boost for free to customers visiting the dealership. As such, a charging program example may be configured for a first session being of type of SRFC (Shorter Range first charged) with added exclusions for the target vehicle that it must be owned by the dealership and have a range of less than 40 miles. If no dealership vehicles have a range of less than 40 miles there will be no target vehicles. A second charge session may be defined as FIFC program with the added exclusion for a target vehicle that it must have received no more than a 10% energy boost since attaching to a charging dispenser and must not belong to the dealership. In the second charging session, when all customers visiting the dealership in a particular day have received at least a 10% energy boost to their electric vehicles, there will be no further target vehicles. For the dealership example, the charging system may be setup to have a default session that runs when no other session has a target vehicle, the default charging session may be a LCFC (low charge first charged) with an exclusionary parameter for the definition of target vehicle that if the vehicle is not a dealership vehicle, then a form of payment must have been made available to the system in order to charge beyond the free charge offered.

In the dealership example, the highest priority may be that all demo vehicles always be ready for a test-drive, thus it may be advisable for the dealer to configure the first charging session not only to take priority over the second charging session but also to be able to interrupt it. In the dealership example, a dealership vehicle may be returning from a test drive with very low remaining range while at least one customer vehicle is being charged. When the returning vehicle is attached to a charging dispenser, the charging program may recognize in it a target vehicle. If the first charging session is configured to be able to interrupt the second charging session, then the second charging session may be replaced by the first charging session. After the interruption by the second charging session, what happens to the connected customer vehicles may depend on the definition of a compatible vehicle in the first charging session. If the first charging session does not define a compatible vehicle as one that, at least, must belong to the dealership, it is possible that a customer vehicle remains connected to the charging system if all other parameters that define a compatible vehicle are met.

The advantageous design of the charging system in this disclosure is that it may charge more than one vehicle concurrently, and thus it may make sense to enlarge the definition of compatible vehicles to accept as many as the charging system can charge efficiently.

In the example of the dealership, it may be desired to charge a returning dealership owned vehicle as fast as possible. Said first charging session may require that a compatible vehicle also meet the requirement that when its battery system is connected to a DC Bus, it does not slow down the charging process of a particular set of charging vehicles (for example, the target vehicle). If a customer attaches to a charging dispenser while dealer vehicles are connected and below the desired range, the customer's vehicle may wait or become ready for charging as long as the parameters do not include an exclusion for vehicles not owned by the dealership.

In the example of the dealership, it is also important to note that once a dealership vehicle has been charged to the desired range, it ceases to be a target vehicle; it does not, however, necessarily become an excluded vehicle. Vehicles are excluded only because, as they are, they cannot become ready to charge regardless of which charging sessions are available. For example, a fully charged vehicle may be an excluded vehicle but simply driving it enough to drain the battery would remove this characterization (or label) once it reattaches to a charging dispenser.

An indicator on a charging dispenser may be available to show that a vehicle has been excluded and that nothing will happen just by waiting. A preferred example of the charging program may drive some method of indicating why a vehicle is excluded.

A vehicle may be excluded from charging if the charging program, for example, is not made aware that a payment method for energy purchase is available. It may be argued that in this case the vehicle should be a waiting vehicle, however, a waiting vehicle may enter a charging session at some point without any further intervention—in the vehicle without a payment method, no amount of wait will charge the vehicle until a payment method is added.

In another example, an “external system able to use said power” of the charge system may not necessarily be “external”, but may actually include the battery systems of any one or more of the vehicles connected to a charging system. In such system, the batteries of one set of vehicles may be used to charge the batteries of a second set. This is achievable if a DC power converter is connected to a second DC Bus which in turn is connected to at least one dispenser in the system. Said DC power converter may then be driven by a charging program in charging mode for a set of vehicles connected to a first DC Bus, and a charging program in discharging mode for a set of vehicles connected to the second DC Bus. A charging dispensers need not be connected to one DC Bus or the other, and may (preferably) make a vehicle connectable to either. This configuration is equivalent to two charging systems, as previously described, that share a DC power converter and parts of one, some or all charging dispensers.

### Example of End-to-End Operation of the System

An important consideration in the operation of a charging system of this disclosure is the proximity of the target inlet voltage of an attached vehicle to the voltage present on the DC Bus. There must be a method, therefore, to obtain said target inlet voltage even when an attached vehicle will not imminently connect to the system. Some implementations of EVCC may provide said target inlet voltage immediately as a response to a read command, however, in many EVCC this value may not be available during the early steps of an EVCC's charging sequence.

An EVCC should not connect an electric vehicle's inlet to the vehicle's battery system unless it detects a voltage at the inlet that it determines is compatible with the battery system. This means that it is guaranteed that the EVCC will provide a vehicle interface with a requested target inlet voltage before the EVCC requests to be connected for charging. If the EVCC is also configured to check the isolation integrity of the charging cable, then the EVCC is expected to request such check before it requests the target inlet voltage. Said request for charging cable isolation and insulation check is common, and it requires from the charging dispenser to place an elevated voltage on the charging cable and determine if there is any current leak. A leak will be reported as an insulation resistance, and if the resistance is determined to be too low, the charge attempt will be aborted. In traditional DC chargers, the DC power converter is able to provide said elevated voltage, however in this disclosure the DC power converter is shared across multiple vehicles and may not have an adequate voltage to check the isolation of the cable plugged into a newly attached vehicle. For this reason, a separate and inexpensive, low current power source may be introduced for the purpose of emulating this functionality. Other methods of validating the isolation integrity of a charging cable are possible, including off-the-shelf components that perform this test standalone. After the isolation (or insulation, for a cable) check has been performed, the EVCC may provide the target inlet voltage sought. Whether the vehicle continues the charging process at this point or not, depends on factors explained below.

When a first electric vehicle is attached to a first charging dispenser, the first charging dispenser and the first electric vehicle may interact in a manner such that a controller within the first charging dispenser becomes aware of, at least, the target inlet voltage of said first electric vehicle. Said first charging dispenser can be any one of many charging dispensers in the charging system and not necessarily the most proximate or the furthest from the DC power converter. A first vehicle has a one-to-one relationship with the DC power converter, and for said first vehicle the charging system of this disclosure may appear to be a traditional charging system. Commencement of charging of said first electric vehicle is well understood in the art.

A subsequent vehicle that attaches to a charging dispenser may not be the first vehicle, and thus, the DC Bus voltage may be under control of the charging program and configured to process charging or discharging of vehicles already connected to a charging system. If a voltage at a DC Bus, rather coincidentally, happens to correspond with the target inlet voltage of a recently attached but not yet connected electric vehicle, then an EVCC of the recently attached vehicle may experience what appears to be a regular DC charging process. Also, if a voltage at a DC Bus is slightly higher than the target inlet voltage, it may be possible for the charging program to temporarily reduce a DC Bus voltage so that it complies with the target inlet voltage of a connecting vehicle, thus also allowing it to connect in a first try (in a discharging scenario the system would slightly raise the DC Bus voltage if the target inlet voltage is slightly higher). It is also possible for the charging program to be configured to disconnect some or all connected vehicles in order to allow for a most recently attached vehicle to be connected imminently. In all of these examples the EVCC on the most recently attached vehicle may experience what appears to be a traditional charge or discharge process, however, one versed in the art will recognize that while the EVCC may experience that it is in control of the charging system, the truth is that the charging system is actually in control, as is discussed in greater detail below.

If a DC Bus of a charging system is at a voltage significantly different from a requested target inlet voltage provided by an EVCC of an electric vehicle, and the charging program is not configured to accept prompt connection of the electric vehicle by promptly adapting the system to the electric vehicle, then the subsequently connected electric vehicle must be made to wait until the DC Bus voltage is compliant with the requested target inlet voltage. If an EVCC can be put on hold or paused by command from the charging system, then the hold option may be used; however, because EVCC are designed to be in charge of a charging process, pausing may not always be possible. A method of implementing a pause for EVCC lacking said functionality may include: a) stopping the charging process; b) making an the EVCC believe that the charging cable has been detached (by manipulation of signals); and, c) making the EVCC believe that it has been reattached (by restoration of signals).

A preferred example of a charging program may make a vehicle wait until the voltage at a DC Bus is significantly similar to a previously stored requested target inlet voltage at a particular charging dispenser before unpausing the charge. In an example this may be achieved by making an EVCC believe that it has been recently reattached to a charger. After a new charge or discharge process is initiated by an EVCC, the stored requested target inlet voltage can be discarded and a requested target inlet voltage provided in an ongoing session should be used instead.

A subsequently connected vehicle will not necessarily connect or remain connected when its target inlet voltage corresponds to the voltage present at the DC Bus. This is the most essential of parameters to define that a vehicle is compatible with the current charging protocol, but others may exist.

Several parameters may be used by the charging program, depending on the example, to determine if an electric vehicle is a compatible vehicle. It is possible, for example, that an example of the charging program or protocol requires that all electric vehicles charge at a rate of at least 5 A; thus, in such an example, a vehicle that cannot be charged at least at 5A is not a compatible vehicle and the vehicle may be disconnected. The charging current is only one example, and even parameters not descriptive of a battery system or a charging system may be considered by the charging program. For example, the charging program may only allow for a vehicle to charge for up to 10 minutes, thus, an electric vehicle that is otherwise chargeable, will not be a compatible vehicle after 10 minutes of charge and may be disconnected. Likewise, a charging program may use inputs from other systems to determine if an electric vehicle is a compatible vehicle, for example, a charging program may only charge vehicles owned by a certain company, thus any vehicle not owned by the certain company are not compatible vehicles and may not be allowed to connect. How a charging system determines who owns a vehicle, or how it obtains any of the parameters to determine if an electric vehicle is a compatible vehicle is not a limiting factor of this description. What means a charging program uses to determine compatibility does not limit the scope of this disclosure.

The example system of this disclosure may be viewed as classifying subsequently attached vehicles according to a set of parameters and taking action upon a said subsequently attached vehicles based on said classification. From most restrictive to least:

If the subsequently attached electric vehicle is determined to be not chargeable, said vehicle shall not be connected to the DC Bus and shall remain mostly ignored until the charging system transitions to a different process (from charging to discharging, for example) or the reason for its inability to charge is resolved otherwise.

If the subsequently attached vehicle is determined to be chargeable but not to be a compatible vehicle, the vehicle will become a waiting vehicle. A waiting vehicle will have its parameters periodically checked to see if it becomes a compatible vehicle. The main difference between a not chargeable vehicle and a waiting vehicle is that a waiting vehicle is expected to become a compatible vehicle without any outside intervention.

If the subsequently attached vehicle is determined to be a compatible vehicle, the charging program may connect the subsequent vehicle's inlet to the DC Bus. The number of steps to execute this connection will depend on the example of the charging system.

If the subsequently attached vehicle is determined to be a target vehicle, said vehicle will take charging priority, the system will configure the DC Bus to correspond to said vehicle's requested inlet voltage (which may include first disconnecting all or some connected vehicles) and will imminently connect said vehicle to the charging system.

Once an electric vehicle is connected to a charger and the charging or discharging process commences, it is expected that said charger will continuously monitor for isolation faults throughout the charging and discharging process. This functionality is easily replicated in the charging system described herein, and in particular, if there are no galvanic isolating components between the DC Bus and the vehicle inlet, then a single isolation monitoring system can check for isolation faults across all vehicles connected to the bus simultaneously. While this approach has the advantage of further decreasing the cost of the system when compared to traditional DC charger designs (which require multiple isolation monitoring systems capable of checking isolation faults while powered), it does have the disadvantage of not being able to determine where an isolation fault happens during the charging or discharging process. Not knowing the source of an isolation fault may cause a charging program to execute a systemic disconnection of all electrical vehicles being charged or discharged as well as a power down of all DC power converters. Isolation faults are extremely rare, however, and if an action is taken to disconnect all vehicles, it is rather simple then to use an isolation fault detection system present at each dispenser for detecting the location of said faults before reconnection. A system may then reconnect all compatible vehicles at dispensers with no fault and continue their charging or discharging process. Said single isolation fault monitoring system can be used to check if the fault occurred on a DC Bus rather than on a vehicle. In short, determination of an isolation fault's location may be difficult as it occurs, but can happen very simply after action is taken.

For some charging systems it may not be acceptable to disconnect the entire system for events of localized isolation faults. In said systems it may be necessary to place an isolation fault monitoring system at each dispenser and the system must be able to filter out any signals from all isolation fault monitoring systems located at other dispensers. This is achievable by a number of methods recognizable by one skilled in the art, including a method where a diode is placed in line (in some cases temporarily) in order to ensure that a measured fault current can only happen at one end of the diode. Said diode method may require a coordinated triggering of the isolation fault checks or the use of specific test voltages. Other methods may include inductive filtering of test signals or even time of flight measurements. Any isolation monitoring method or a combination thereof may enhance the functionality of an embodiment of the Charging System described.

Isolation integrity is just one of the parameters that a system may monitor; in addition, it may monitor the power used by the entire system, temperatures at dispenser connectors, environmental temperatures and several other parameters to ensure the safe and adequate operation of the system. Primarily, however, the system will monitor the charging parameters of all battery systems connected to the charging system and will ensure that no critical parameter is surpassed. Some critical parameters are maximum voltage, maximum current, minimum voltage, maximum power, minimum temperature, maximum temperature and others. When some parameters are in proximity of reaching their limits, the system may either adjust the DC Bus voltage to prevent surpassing them, or may disconnect a vehicle under such imminent condition. One common example of this is when a vehicle has achieved what is determined to be a full charge. Another example is when a battery system is about to overheat.

Other than parameters that determine the chargeability of a connected vehicles, other, less critical parameters may also cause disconnection of a vehicle. For example, a vehicle may become incompatible with a target inlet voltage of a target vehicle, in which case any such vehicle would be disconnected in order for said target vehicle to connect. In other cases, it is possible for a vehicle to become incompatible with a new charging protocol. For example, in a system that is configured to only charge company vehicles after 6 pm, any customer vehicles connected to the system past said time will become incompatible and may be disconnected even if otherwise they could remain connected.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

1. An electric vehicle charging system, comprising:
a charging system controller having a processor and computer-readable memory;
a DC power converter;
a DC Bus comprising at least a positive and a negative set of voltage lines; and
at least two charging dispensers in electrical communication with the DC power converter along the DC Bus, each of the at least two charging dispensers electrically connectable to an electric vehicle,
wherein the charging system controller is configured to:
acquire a target inlet voltage requested by a first chargeable electric vehicle;
acquire a target inlet voltage requested by at least one subsequent chargeable electric vehicle;
control a voltage of the DC Bus to correspond to the target inlet voltage requested by the first chargeable electric vehicle; and
connect any of the first chargeable electric vehicle or the at least one subsequent chargeable electric vehicle having a target inlet voltage corresponding to the voltage of the DC Bus, thereby enabling charging of ay connected electric vehicle.

2. The electric vehicle charging system of claim 1, wherein the charging system controller is further configured to disconnect any of the first chargeable electric vehicle or the at least one subsequent chargeable electric vehicle upon subsequent vehicle connection.

3. The electric vehicle charging system of claim 1, wherein the charging system controller is further configured to:
adjust the voltage of the DC Bus to correspond to a target inlet voltage of a chargeable vehicle different of the connected first chargeable electric vehicle or the connected at least one subsequent chargeable electric vehicle; and
connect, or maintain connection of, any of the first chargeable electric vehicle or the at least one subsequent chargeable electric vehicle able to connect or remain connected to the DC Bus at a voltage corresponding to the adjusted voltage.

4. The electric vehicle charging system of claim 3, wherein the charging system controller is further configured to disconnect any of the connected first chargeable electric vehicle or the connected at least one subsequent chargeable electric vehicle upon subsequent vehicle connection.

5. The electric vehicle charging system of claim 1, wherein the charging system controller is further configured to connect any of the first chargeable electric vehicle or the at least one subsequent chargeable electric vehicle if the target inlet voltage of the first chargeable electric vehicle or the at least one subsequent chargeable electric vehicle subsequently corresponds to the voltage of the DC Bus.

6. The electric vehicle charging system of claim 1, wherein the voltage of the DC Bus is determined by at least one from the set of:
selecting a voltage corresponding with a most recent requested target inlet voltage,
selecting a voltage corresponding with the lowest requested target inlet voltage,
selecting a voltage corresponding with an earliest chargeable electric vehicle,
selecting a voltage corresponding with an electric vehicle having a lowest state of charge, and
selecting a voltage corresponding with a chargeable electric vehicle having a shortest travel range.

7. The electric vehicle charging system of claim 1, wherein when the first chargeable electric vehicle becomes disconnected, the voltage of the DC Bus is determined by the at least one subsequent chargeable electric vehicle selected from the set of:
corresponding with a last attached electric vehicle,
corresponding with an attached electric vehicle having a lowest battery system voltage,
corresponding with an earliest attached electric vehicle,
corresponding with the attached electric vehicle having a lowest state of charge, and
corresponding with the attached electric vehicle having a shortest travel range.

8. A method of charging a plurality of electric vehicles, comprising the following steps:
providing a charging system having:
a charging system controller having a processor and computer-readable memory;
a shared DC power converter;
a DC Bus comprising at least a positive and a negative set of voltage lines; and
at least two charging dispensers in electrical communication with the shared DC power converter along the DC Bus each of the at least two charging dispensers electrically connectable to an electric vehicle;
attaching a first electric vehicle and at least one subsequent electric vehicle to the charging system at any of the at least two charging dispensers;
commencing a charge process of the first electric vehicle;
acquiring a target inlet voltage from the at least one subsequent electric vehicle;
comparing the target inlet voltage with a voltage of the DC Bus; and
connecting the at least one subsequent electric vehicle when the voltage of the DC Bus is appropriately proximate the target inlet voltage, thereby enabling charging or discharging of any connected electric vehicle by subsequent control of the shared DC power converter.

9. The method of claim 8, further comprising the step of sending, by the charging system controller, a signal to at least one of the charging dispensers to communicate to the electric vehicle attached thereto that the chargeable electric vehicle must disconnect, then re-connect.

10. The method of claim 8, wherein the charging system controller is further configured to control the voltage of the DC Bus to not surpass, for any connected vehicle, at least one parameter from the set of: battery maximum voltage, battery minimum voltage, maximum current, and limit battery temperature.

11. The method of claim 8, further comprising the step of changing, by the charging system controller, the voltage of the DC Bus to correspond to a changed charge state of at least one connected electric vehicle, wherein the change in the voltage of the DC Bus is:
an increase in the voltage of the DC Bus, corresponding to an increased charge state, or
a decrease in the voltage of the DC Bus corresponding to a decreased charge state.

12. The method of claim 8, wherein the voltage of the DC Bus is determined by selecting a voltage corresponding with the lowest requested target input voltage first and continuing numerically to the highest requested target input voltage.

13. The method of claim 8, wherein the voltage of the DC Bus is determined by selecting a voltage corresponding with an earliest chargeable electric vehicle.

14. The method of claim 8, wherein the voltage of the DC Bus is determined by selecting a voltage corresponding with an electric vehicle having a lowest state of charge.

15. The method of claim 8, wherein the voltage of the DC Bus is determined by selecting a voltage corresponding with a chargeable electric vehicle having a shortest travel range.

16. The method of claim 8, further comprising the step of making the at least one subsequent electric vehicle wait until the DC Bus is appropriately proximate the target inlet voltage by:
making it appear to the at least one subsequent electric vehicle that is no longer attached to a charge dispenser;
monitoring and comparing the voltage of the DC Bus controlled by the charging system controller; and
making it appear to the at least one subsequent electric vehicle that it has been reattached to a charge dispenser when the DC Bus is proximate the target inlet voltage.

17. A method of selectively charging one vehicle, comprising the steps of:
providing a charging system having:
a charging system controller having a processor and computer-readable memory;
a shared DC power converter;
a DC Bus comprising at least a positive and a negative set of voltage lines;
at least two charging dispensers in electrical communication with the DC power converter along the DC Bus, each of the at least two charging dispensers electrically connectable to an electric vehicle; and
at least one electric vehicle connected to any of at least two charging dispensers, wherein the at least one electric vehicle is being charged by a voltage of the DC Bus controlled by the charging system controller;
attaching a subsequent chargeable vehicle to any available of the at least two charging dispensers;
determining that the chargeable vehicle takes charging priority over all of the at least one electric vehicle connected to any of at least two charging dispensers;
acquiring a target inlet voltage from the chargeable vehicle determined to have priority;
disconnecting at least all connected vehicles incompatible with the target inlet voltage from the chargeable vehicle determined to have priority;
adjusting the voltage of the DC Bus to appropriately approximate the target inlet voltage of the chargeable vehicle determined to have priority; and
connecting the chargeable vehicle determined to have priority to the DC BUS.

18. An electric vehicle fleet charging system, comprising:
a charging system controller having a processor and computer-readable memory;
a DC power converter;
a DC Bus comprising at least a positive and a negative set of voltage lines; and
a plurality of charging dispensers in electrical communication with the DC power converter along the DC Bus each of the plurality of charging dispensers electrically connectable to an electric vehicle of an electric vehicle fleet,
wherein the charging system controller is configured to:
acquire a target inlet voltage requested by a first chargeable electric vehicle of the electric vehicle fleet;
acquire a target inlet voltage requested by at least one subsequent chargeable electric vehicle of the electric vehicle fleet;
control a voltage of the DC Bus to correspond to the target inlet voltage requested by the first chargeable electric vehicle; and
connect any of the first chargeable electric vehicle or the at least one subsequent chargeable electric vehicle of the electric vehicle fleet having a target inlet voltage corresponding to the voltage of the DC Bus thereby enabling charging or discharging of any connected electric vehicle of the electric vehicle fleet by subsequent control of the DC Bus.

19. The electric vehicle fleet charging system of claim 18, wherein the charging system controller is further configured to disconnect any of the first chargeable electric vehicle or the at least one subsequent chargeable electric vehicle upon subsequent vehicle connection.

20. The electric vehicle fleet charging system of claim 18, wherein the charging system controller is further configured to:
adjust the voltage of the DC Bus to correspond to an inlet voltage of a chargeable vehicle different of all connected vehicles of the first chargeable electric vehicle or the at least one subsequent chargeable electric vehicle; and
connect, or maintain connection of, any of the first chargeable electric vehicle or the at least one subsequent chargeable electric vehicle able to connect or remain connected to the DC Bus at a voltage corresponding to the adjusted voltage of the DC Bus.

21. The electric vehicle fleet charging system of claim 18, wherein the charging system controller is further configured to connect any of the first chargeable electric vehicle or the at least one subsequent chargeable electric vehicle if the target inlet voltage of the first chargeable electric vehicle or the at least one subsequent chargeable electric vehicle subsequently corresponds to the voltage of the DC Bus.
